(19) United States
(12) Patent Application Publication
(10) Pub. No.: US 2008/0105064 A1
(43) Pub. Date: May 8, 2008

(54) Method And A Device For Taking Samples When Measuring Ph, Conductivity, Redox Potential And/Or Other Ion-Concentrations In Liquids, Including Washing Of Electrodes And A Suction Circuit

(76) Inventor: Arve Halland, Odda (NO)

Correspondence Address: PATTERSON & SHERIDAN, L.L.P., 3040 POST OAK BOULEVARD, SUITE 1500, HOUSTON, TX, 77056, US

(21) Appl. No.: 11/813,523

(22) PCT Filed: Jan. 11, 2006
(86) PCT No.: PCT/NO06/00011

§ 371 Date: Aug. 29, 2007

(30) Foreign Application Priority Data
Jan. 12, 2005 (NO) 20050168

(51) Int. Cl. G01N 27/38

(52) U.S. Cl. 73/864.35

(57) ABSTRACT

A method and a device for taking samples when measuring pH, conductivity, redox potential and/or other ion-concentrations in liquids, including washing of electrodes and a suction circuit. The sampling is characterized in that a vacuum is created in the sampling chamber (1) at (8) in order to suck the sample. After the sampling and measuring has been performed, the sampling chamber (1) is drained, and the sampling chamber (1) is then sprayed with a detergent solution and/or water by one or more jet nozzles (4). The nozzle orifices face upwards, ensuring that the jets hit the tip (9) of the measuring electrode (3) or measuring electrodes, and also the inlet (16). Generating a vacuum at (8) simultaneously with the jetting causes water and/or detergent solution to be sucked into the suction circuit, cleaning it of dirt and deposits.

The invention regards a device and a method of taking samples when measuring pH, conductivity, redox potential and/or other ion-concentrations in liquids, for use in industry, sewage treatment plants and for environmental monitoring. The measurements are generally used for automatic control of processes and/or monitoring of processes or the environment.

In many processes it is difficult to perform this type of measuring on a continuous basis. This may be due to soiling of the electrodes, deposits forming on the electrode surface or contamination of the electrodes. Using a sampling device reduces these problems considerably. Sampling devices that perform intermittent measurements have the advantage of the electrode being in contact with the liquid for a shorter time than in the case of continuous measurements. Some sampling devices also wash the electrodes. Another advantage of sampling devices is that it is easy to calibrate the measurements, it is easy to change electrodes, and the sampling devices can be use for taking samples in tanks with varying levels. The risk of mechanical damage to the electrodes is reduced. Having several feed lines and valves between the process and the sampling device allows a sampling device to have several monitoring points. Reference is also made to Norwegian patent no. 126 935, German patent no. DE 31 51 396 A1 and German patent no. DE 34 05 962 A1.

Current sampling devices work by sucking the liquid up into the sampling chamber by use of underpressure (vacuum). For that matter, this also applies to the present invention. In the following, the components utilised to create and generate a vacuum for the sampling chamber, e.g. the connecting pipes, valve and vacuum pump, is termed a “suction circuit”. The problem of today's sampling devices is that particles, steam, gases and some liquids are sucked into the suction circuit, causing blockage after a while. This causes the sampling device to shut down and requires manual cleaning of the suction circuit; alternatively today's sampling devices must be provided with extra facilities for automatic cleaning of the suction circuit, in order to function for a longer period. This makes the sampling device more complex. Another weakness of today's sampling devices is the lack of direct washing or spraying of the sensitive electrode surface. The sensitive tip of the electrode or electrodes generally faces downwards. Direct spraying of the sensitive tip increases the effect of the spraying considerably compared with indirect spraying. These problems are overcome by this invention.

The invention is characterized in that the sampling chamber is equipped with one or more jet nozzles facing upwards. After the sampling chamber has been drained, these will spray up towards the suction hole. The invention is further characterized in that the sensitive electrode surface is cleaned by the tip of the electrode or electrodes being washed/sprayed from below with water or a suitable detergent solution, by one or more jet nozzles, and in that the suction circuit is cleaned by means of the same nozzle. This is achieved by arranging the jet nozzle in a way such that the spray from the nozzle hits both the tip of the electrode or electrodes from below, and the suction hole in the lid, and by sucking simultaneously with the jetting, after the sampling chamber has been drained of liquid. The invention will also make it possible to construct a sampling device where the electrodes are washed from below, and a suction circuit with few components. The invention provides significantly higher operational reliability and a far more reasonable production of sampling devices than that represented by the state of the art.

The invention then, regards a method and a device for taking samples. The invention will be explained below, with reference to the drawing, in which is shown an example of a practical embodiment of the device of the invention.

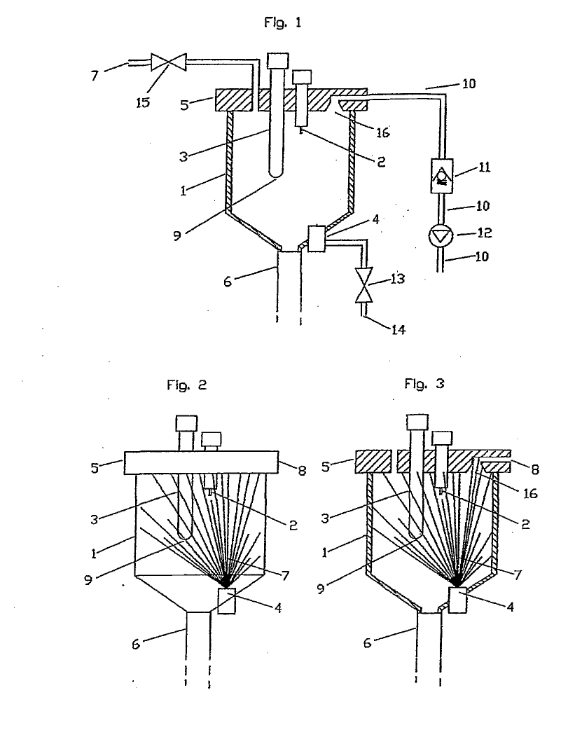

FIG. 1 shows the sampling device with a cross section of the chamber 1 and the lid 5. FIG. 2. is a side view of the sampling chamber 1 etc., during jetting by the nozzle 4. FIG. 3 is a side view of the transparent sampling chamber etc., during jetting by the nozzle 4, with a cross section of the chamber 1 and the lid 5. The valve 15 is connected to atmospheric pressure or an appropriate overpressure at 7. The valve 13 is connected to pressurized water or a suitable pressurized detergent solution at 14. The operation of the sampling device is sequential. During operation of the sampling device, the measuring cycle starts at step 1; when step 1 is completed, step 2 is initiated; when step 2 is completed, step 3 is initiated etc. A measuring cycle normally consists of the following steps:

Step 1.

The vacuum pump 12 is started and the liquid is sucked into the sampling chamber I through the inlet pipe 6. The admission of liquid is stopped when the liquid level reaches level electrode 2.

Step 2.

The sample is then retained in the sampling chamber 1 by the reduced pressure in the sampling chamber 1. The sampling chamber 1 contains at least one measuring electrode 3. When the sample has stabilized the measurement is performed by means of measuring electrode 3.

Step 3.

The valve 15 opens and the sampling chamber 1 is drained by allowing the liquid to flow out of the sampling chamber 1 through inlet pipe 6.

Step 4.

The sampling chamber 1 contains at least one upward facing jet nozzle 4. The measuring electrode 3, the level electrode 2 and the inside of the sampling chamber 1 and the lid 5 are then cleaned by a spray from the nozzle 4. The valve 15 can be open during this spraying.

Step 5.

The valve 15 is open and the sampling chamber 1 is drained of detergent solution by the wash water and/or detergent solution being allowed to flow out of the sampling chamber 1 through the inlet pipe 6.

Step 6.

The suction circuit, consisting of the connecting pipes 10, the check valve 11 and the vacuum pump 12, is then cleaned by the sampling chamber 1 again being placed under a vacuum through start-up of the vacuum pump, while the jet nozzle 4 or jet nozzles spray water and/or a suitable detergent solution. The water and/or detergent solution is then sucked into the suction circuit, cleaning it. The valve 15 can be open.

Step 7.

The valve 15 is open and the sampling chamber 1 is drained of detergent solution by the allowing the wash water and/or detergent solution to flow out of the sampling chamber 1 through inlet pipe 6.

After step 7 has been completed, the sequence may be repeated for continuous operation of the sampling device, or the sampling device may be shut down and the measuring cycle started up again after a certain period or at set times.

1. A method for washing a suction circuit (8, 10, 11, 12, 16) of a sampling device, where the sampling device comprises a sampling chamber (1) having a lid (5), wherein the sampling chamber (1) communicates with a sample fluid via an inlet pipe (6), and where a level electrode (2) and at least one measuring electrode (9) projects down from the lid (5) into the sampling chamber (1), at least one cleaning nozzle (4) being arranged to spray detergent at least towards the measuring electrode (9), and where the sample fluid is sucked up through the inlet pipe (6) and into the sampling chamber (1) by a vacuum, for sampling, characterized in that the cleaning nozzle (4) also sprays cleaning fluid into the suction circuit (8, 10, 11, 12, 16) while cleaning at least the measuring electrode (9).

2. A method in accordance with claim 1, characterized in that the vacuum pump (12) of the suction circuit (8, 10, 11, 12, 16) sucks cleaning fluid through the suction circuit (8, 10, 11, 12, 16) for at least part of the spray cycle of the cleaning nozzle (4).

3. A device for cleaning a suction circuit (8, 10, 11, 12, 16) of a sampling device, where the sampling device comprises a sampling chamber (1) having a lid (5), wherein the sampling chamber (1) communicates with a sample fluid via an inlet pipe (6), and where a level electrode (2) and at least one measuring electrode (9) projects down from the lid (5) into the sampling chamber (1), at least one cleaning nozzle (4) being arranged to spray detergent at least towards the measuring electrode (9), and where the sample fluid is sucked up through the inlet pipe (6) and into the sampling chamber (1) by a vacuum, for sampling, characterized in that the jet(s) from the cleaning nozzle (4) is/are directed at the inlet (16) to the suction circuit (8, 10, 11, 12, 16) in addition to being directed at least at the measuring electrode (9).
A device in accordance with claim 3, characterized in that the inlet (16) is located in the lid (5).
